(19) United States
(12) Patent Application Publication
(10) Pub. No.: US 2003/0206082 A1
(43) Pub. Date: Nov. 6, 2003

(54) Waveguide filter with reduced harmonics

(76) Inventors: Ming Hui Chen, Ranchos Palos Verdes, CA (US); Wei-Tse Cheng, Tainan Hsien (CN)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 10/140,346

(22) Filed: May 6, 2002

(51) Int. Cl. H01P 1/207

(52) U.S. Cl. 333/208

(57) ABSTRACT

A waveguide filter made a rectangular waveguide section 12 with cavities 14 forming resonators spaced along opposite walls of the waveguide is configured to reduce the harmonic passband amplitude noise due to higher order harmonics. The cavities 14 are modified from conventional cavities by having different lengths L₁-L₈ and widths A₁-A₈, as opposed to equal length and equal width values. Each cavity is designed to resonate at the desired principal frequency f1 according to the combination of the cavity width and length, but with cavities having different lengths and widths, synchronous resonances do not occur at higher order harmonic frequencies f2 and f3 normally occurring when the cavities all have equal widths and equal lengths.

### BACKGROUND OF THE INVENTION

1. Field of the Invention

The present invention relates to a waveguide filter configured to reduce the amplitudes of harmonic pass bands.

2. Background

A typical waveguide band filter is a TE10 mode waveguide filter. A perspective view of such a filter is shown in FIG. 1A. The TE10 mode waveguide includes a conducting waveguide 2 having a rectangular cross-sectional shape with cavities 4 forming resonators. An end view of the waveguide filter of FIG. 1A is shown in FIG. 1B. The width W₁ and height H₁ of the cross-section of the waveguide 2 shown in FIG. 1B are chosen along with the waveguide length L₁ to allow wave propagation of signals at the operating frequency bandwidth of interest while causing frequencies outside the operating bandwidth to reflect.

Resonant cavities 4 formed in opposing walls of the waveguide enable the waveguide to act as a filter. The cavities are formed between irises, such as iris 6, which extend from the waveguide walls. FIG. 1C shows across-section CC from FIG. 1B illustrating placement of the cavities. By placing multiple resonator cavities of the same width A₁=A₂=A₃=A₄=A₅=A₆=A₇=A₈, height (matching H₁ of waveguide), and same length L₁=L₂=L₃=L₄=L₅=L₆=L₇=L₈ along a waveguide, resonances are introduced resulting in a bandpass filter. The widths Ai, where i=1, 2, 3 . . . 8 for FIGS. 1A-1C, determine the guide wavelength of cavity i at the pass band principle frequency of operation f1, f1 being the center of the pass band. The lengths Li, where i=1, 2, 3 . . . 8 for FIGS. 1A-1C, are ½ of λ_{g} at f1. Selection of dimensions for Ai and Li in this manner provides a synchronously tuned filter operating over a desired precise bandwidth with center frequency f1 within the bandwidth of the original waveguide.

Currently existing TE10 mode waveguide filters, as illustrated in FIGS. 1A-1C, will have transmission characteristics over a frequency band as shown in FIG. 2. An undesirable feature of the waveguide shown in FIGS. 1A-1C is that higher order harmonics are allowed to propagate. Transmission at harmonic frequencies will result when the cavities reach multiple resonances, such as when the cavities resonate at f2 when Li are all at one guide wavelength, or at f3 when Li are at 1 ½ the a guide wavelength. The undesirable transmission characteristics due to second and third order harmonics are shown at approximately f2=25 GHz and f3=35 GHz in FIG. 2. To eliminate the harmonic pass band, a low pass filter is typically connected to the waveguide filter.

### SUMMARY

The present invention provides a TE10 mode waveguide bandpass filter with cavity resonators, the waveguide filter being configured to reduce the amplitude of harmonic pass bands due to high order harmonics without using an added low pass filter section.

The waveguide filter in accordance with the present invention is configured to reduce the amplitude of the harmonic pass band by including cavity resonator sections having lengths Li and widths Ai which are different for i, as opposed to the equal lengths and widths for all i with the design of FIGS. 1A-1C. The cavity lengths and widths are chosen to have dimensions so that all the cavities resonate at the center frequency f1 of a desired passband, but the lengths and widths are chosen to have different values for different values of i. Although each cavity is synchronously tuned to resonate at f1, with different dimensions Li and Ai for different values of i, the cavities will not all resonate synchronously at frequencies f2 or f3. With different length and width cavities, second and third order harmonics are substantially reduced.

### BRIEF DESCRIPTION OF THE DRAWINGS

The present invention will be described with respect to particular embodiments thereof, and references will be made to the drawings in which:

FIG. 1A shows a perspective view of a conventional waveguide filter with identical cavities;

FIG. 1B shows an end view of the waveguide filter of FIG. 1A;

FIG. 1C shows a cross section CC′ from FIG. 1B;

FIG. 2 shows a typical transmission characteristics of a waveguide filter as shown in FIGS. 1A-1C with the desired fundamental pass band and undesired second and third harmonics;

FIG. 3A shows a waveguide filter in accordance with the present invention having non-identical cavities;

FIG. 3B shows an end view of the waveguide filter of FIG. 3A;

FIG. 3C shows a cross section CC′ from FIG. 3B; and

FIG. 4 shows transmission characteristics of the waveguide filter of FIGS. 3A-3C with a passband fundamental frequency set to the same fundamental frequency as the waveguide providing the results of FIG. 2.

### DETAILED DESCRIPTION

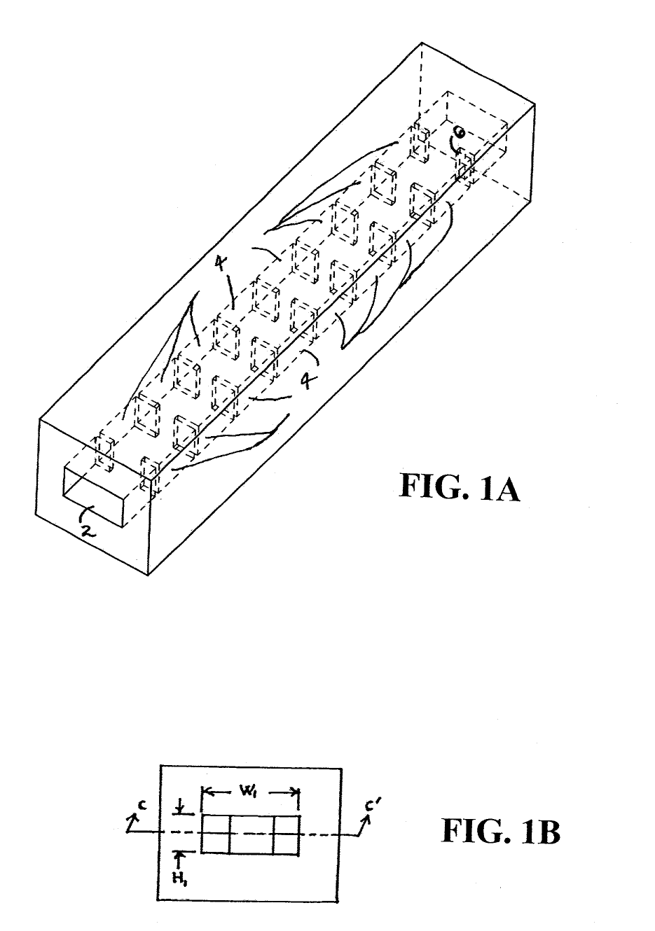

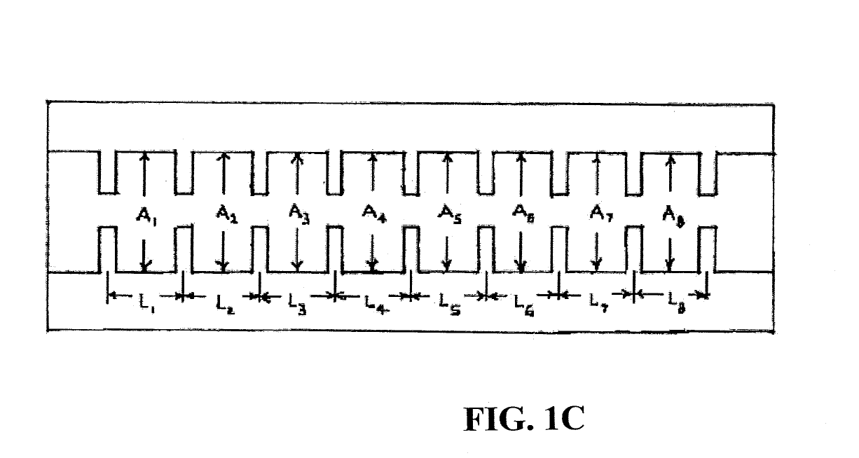

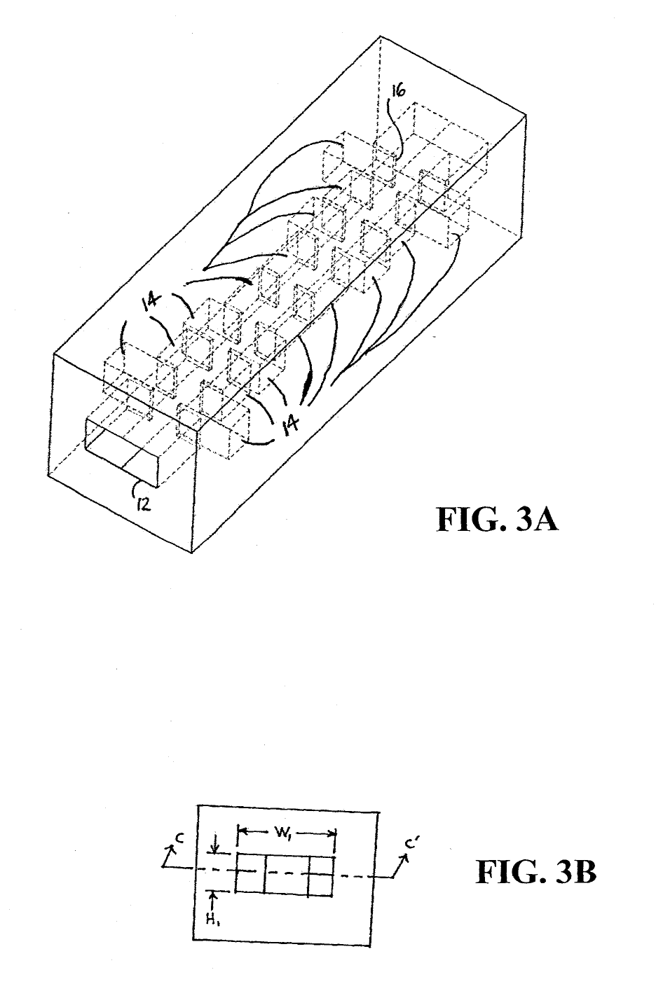

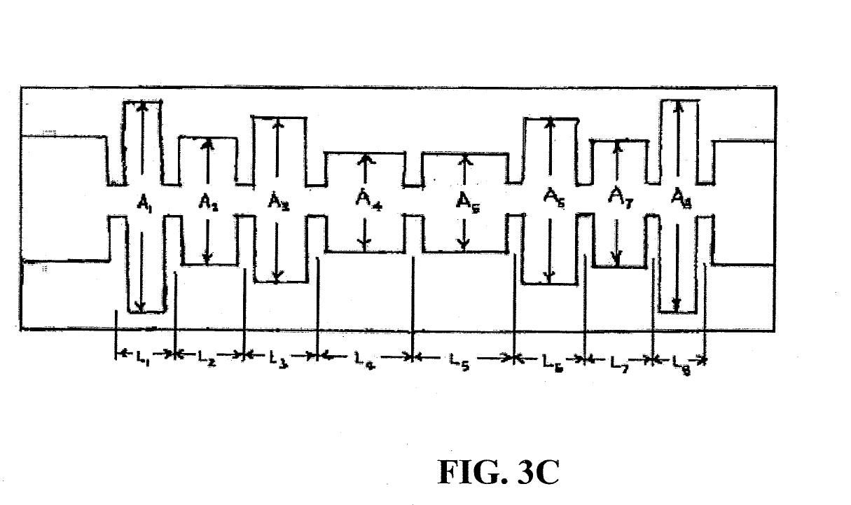

FIG. 3A shows a perspective view of a waveguide filter in accordance with the present invention. Similar to FIG. 1A, the filter of FIG. 3A includes a waveguide 12 having a plurality of cavity resonators 14. FIG. 3B shows an end view of the waveguide of FIG. 3A having a width W₁ and height H₁.

The resonant cavities 14 are formed between irises, such as iris 16, extending from opposing walls of the waveguide. FIG. 3C shows a cross-section CC′ from FIG. 3B illustrating placement and dimensions of the cavities. The cavities each have a common height equal to the height H₁ of the waveguide, but widths Ai and lengths Li having different values for different i, where i=1, 2, 3 . . . 8 for FIGS. 3A-3C, as opposed to equal widths Ai and lengths Li of FIGS. 1A-1C. Although having different dimensions for different cavities, Ai and Li are set so all the cavities resonate at a center frequency f1 of a desired passband. The length Li for each cavity i is set to be 1 of the guide wavelength of that cavity. The guide wavelength for each cavity is determined by the cavity width Ai. Although each cavity has a length designed to resonate at the desired principal frequency f1 according to the combination of the length and width, with different length and width values of the cavities resonance will not occur at common higher order frequencies normally occurring when the cavities all have the same length and width dimensions.

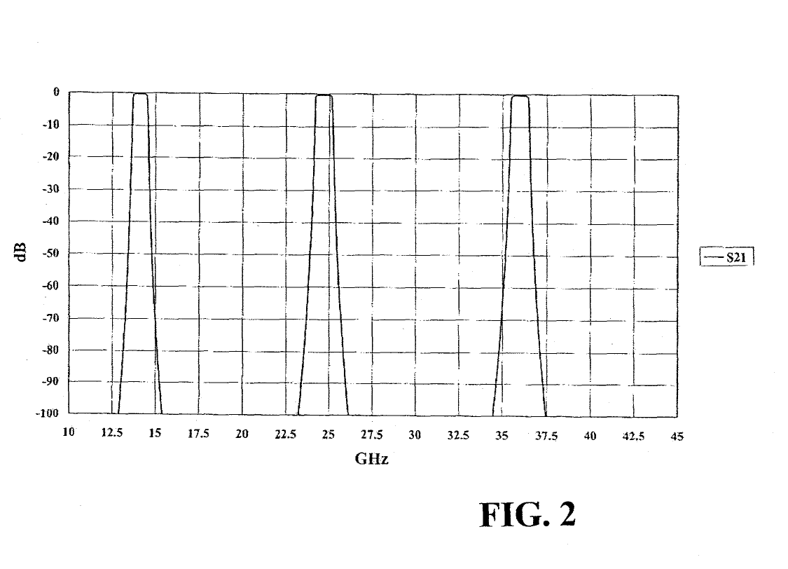

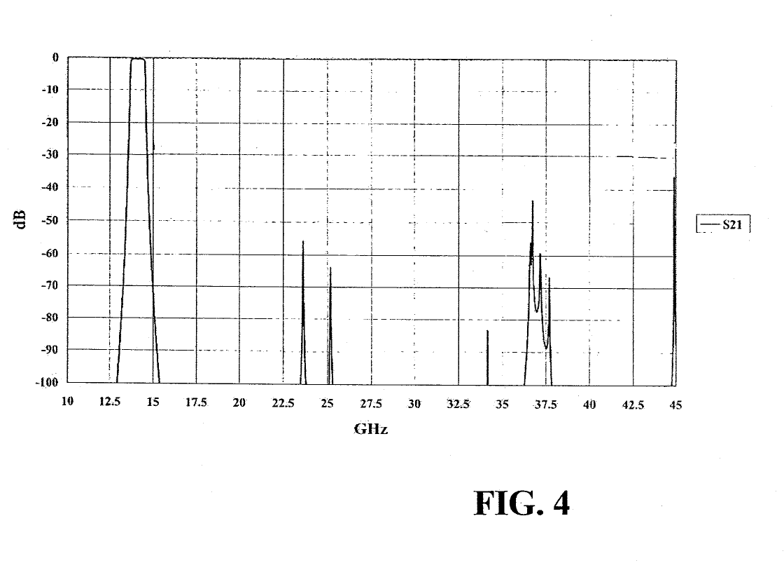

FIG. 4 shows transmission characteristics of the waveguide filter of FIGS. 3A-3C with a passband fundamental filter frequency set to the same frequency f1 as the waveguide providing the results of FIG. 2. As shown in FIG. 4, the waveguide filter of FIGS. 3A-3C will have a significantly lower amplitude of harmonic pass bands at f2=25 GHz and f3=35 GHz. A low pass filter typically connected to the waveguide filter to eliminate higher order harmonics will, thus, not be required.

The waveguide filter can be manufactured by cutting rectangular stock aluminum in half, and machining the waveguide and cavities in each section, and then connecting the sections back together. The sections can be used to form molds so that the waveguide structure can be built using the die-casting technology for low manufacturing costs.

Although the present invention has been described above with particularity, this was merely to teach one of ordinary skill in the art how to make and use the invention. Many other modifications will fall within the scope of the invention, as that scope is defined by the claims provided to follow.

What is claimed is:

1. A waveguide filter comprising:
a plurality of waveguide walls formed in metal forming a waveguide; and
cavity resonators formed between adjacent irises extending from each of opposing ones of the waveguide walls, wherein the cavity resonators have cavity width dimensions Ai running parallel with extension of the irises between the opposite walls, and cavity length dimensions Li running between adjacent ones of the irises, wherein i is a whole number representing different ones of the cavities, and wherein the cavity width dimensions Ai and cavity length dimensions Li differ.

2. The waveguide filter of claim 1, wherein the cavity width dimensions Ai and the cavity length dimensions Li are set to tune resonation for the cavity resonators to a common frequency f1.

3. The waveguide filter of claim 1, wherein the cavity resonators contain at least one pair of cavity resonators having equal cavity length dimensions.

4. A method of manufacturing a waveguide filter comprising the steps of:
forming a rectangular waveguide in metal; and
forming cavity resonators by forming cavities between adjacent irises extending from each of opposing ones of the waveguide walls, wherein the cavity resonators have cavity width dimensions Ai running parallel with extension of the irises between opposite walls, and cavity length dimensions Li running between the adjacent irises, wherein i is a whole number representing different ones of the cavities, and wherein the cavity width dimensions Ai and cavity length dimensions Li differ.

5. The method of manufacturing a waveguide filter of claim 4, wherein the steps are performed by cutting a block of metal in two portions, machining the metal and attaching the two portions back together.

6. The method of manufacturing a waveguide filter of claim 4, wherein the steps are performed by pouring metal into a mold.
